(19) United States
(12) Patent Application Publication
(10) Pub. No.: US 2015/0302467 A1
(43) Pub. Date: Oct. 22, 2015

(54) SYSTEM AND METHOD FOR REAL TIME SELECTION OF AN OPTIMAL OFFER OUT OF SEVERAL COMPETITIVE OFFERS BASED ON CONTEXT

(71) Applicant: TAPTICA LTD, Tel Aviv (IL)

(72) Inventor: Kobi MARENKO, Tel Aviv (IL)

(21) Appl. No.: 14/693,273

(22) Filed: Apr. 22, 2015

Related U.S. Application Data
(60) Provisional application No. 61/982,352, filed on Apr. 22, 2014.

(51) Int. Cl. G06Q 30/02

(52) U.S. Cl. CPC G06Q 30/0247; G06Q 30/0275

(57) ABSTRACT

A real-time selection system and method for selecting an optimal offer out of at least two competitive offers, set towards at least one incoming request. The system includes a processor and a database. The database may be one or more of an offers database, an impressions database, a clicks database, a click through database, a conversions database, a requests database, a users database, a biddings database, and hash table features.

### BACKGROUND OF THE INVENTION

The present invention refers to the arena of real-time bidding (RTB) by which ad inventory is bought and sold on a per-impression basis, via programmatic instantaneous auction, similar to financial markets. With real-time bidding, advertising buyers bid on an impression and, if the bid is won, the buyer's ad is instantly displayed on the publisher's site. Real-time bidding is a dynamic auction process where each request for impression is bid for in real-time.

A typical transaction begins with a user visiting a mobile application or web application. This triggers a bid request that can include various pieces of data such as the user's demographic information, browsing history, location, and the page being loaded. The request goes from the publisher to an ad exchange, which submits it and the accompanying data to multiple advertisers who automatically submit bids in real-time to place their ads. Advertisers bid on each ad impression as it is served. The impression goes to the highest bidder and their ad is served on the mobile page. This process is repeated for every ad slot on the mobile and/or web page. Real time bidding transactions typically happens within 100 milliseconds.

The bidding happens autonomously and advertisers set maximum bids prices and budgets for an advertising campaign. The criteria for bidding on particular types of request can be very complex, taking into account everything from very detailed behavioral profiles to conversion data.

Demand Side Platforms (DSPs) give buyers direct RTB access to multiple sources of inventory. They typically streamline ad operations with applications that simplify workflow and reporting. DSPs are directed at advertisers. The technology that powers an ad exchange can also provide the foundation for a DSP, allowing for synergy between advertising campaigns.

Large publishers often connected to multiple advertising networks and use supply side platforms (SSPs) to manage advertising yield. Supply side platform utilize data generated from impression-level bidding to help tailor advertising campaigns. Applications to manage ad operations are also often bundled into SSPs. SSP technology is adapted from ad exchange technology.

A consumer's history is currently very difficult to determine in the internet and mobile world. This is due to technical limitations that continue to make the type of targeting and tracking available on the desktop essentially impossible on smart phones and tablets. The lack of a universal cookie alternative for mobile web browsing also limits the growth and feasibility of programmic ad buying.

Auer et al., as in Society for Industrial and Applied Mathematics, Vol. 32, No. 1, pp. 48-77, refers to the multi-armed bandit problem. In their study there are no statistical assumptions whatsoever about the nature of the process generating the payoffs of the slot machines. A solution is given to the bandit problem in which an adversary, rather than a well-behaved stochastic process, has complete control over the payoffs. In a sequence of T plays, it is proved that the per-round payoff of our algorithm approaches that of the best arm at the rate O(T^{-½}). In is shown by a matching lower bound that this is the best possible. Auer et al., further disclose an algorithm that approaches the per-round payoff of any set of strategies at a similar rate: if the best strategy is chosen from a pool of N strategies, then our algorithm approaches the per-round payoff of the strategy at the rate O((log N)^{1/2}T^{-1/2}).

McMahan et al., Proceedings of the 19th ACM SIGKDD International Conference on Knowledge Discovery and Data Mining (KDD) (2013), discloses predicting ad click through rates (CTR) is a massive-scale learning problem that is central to the multi-billion dollar online advertising industry. They present improvements in the context of traditional supervised learning based on an FTRL-Proximal online learning algorithm (which has excellent sparsity and convergence properties) and the use of per-coordinate learning rates. The further disclosed useful tricks for memory savings, methods for assessing and visualizing performance, practical methods for providing confidence estimates for predicted probabilities, calibration methods, and methods for automated management of features.

### SUMMARY OF THE INVENTION

It is one object of the present invention to provide a method for real-time selection of optimal-offer out of at least two offers O_{i,i=1 . . . N≧2}, set towards at least one incoming request; the method comprising real-time steps of:
a. providing a processor [110], configured for controlling operation of the selection;
b. parsing the at least one request to a request-context-vector;
c. calculating at least two estimated-CTRs ECTRᵢ, each for different offer of the at least two of offers Oᵢ, based on the request-context-vector and at least two first-weight-vectors W1ᵢ each configured for different offer of the at least two offers Oᵢ;
d. calculating at least two estimated-CRs ECRᵢ each for different offer of the at least two of offers Oᵢ, based on the request-context-vector and at least two second-weight-vectors W2ᵢ each configured for different offer of the at least two offers Oᵢ;
e. calculating at least two scores Sᵢ each for different offer of the at least two offers Oᵢ, based on the at least two estimated-CTRs ECTRᵢ and the at least two estimated-CRs ECRᵢ;
f. calculating a choosing-probability Pᵢ for each offer of the at least two offers Oᵢ, based on the score Sᵢ; and
g. selecting the optimal-offer;
wherein the steps of calculating at least two estimated-CTRs and calculating at least two estimated-CRs are based on at least one previously selected the optimal-offer.

It is another object of the present invention to provide the method as defined above, wherein the step of selecting the optimal-offer is according to at least one characteristic selected from a group consisting of: highest the score Sᵢ, highest the estimated-CTR ECTRᵢ, highest the estimated-CRs ECRᵢ, highest the choosing probability Pᵢ, lowest the choosing probability Pᵢ, random of the choosing probability Pᵢ and any combination thereof.

It is another object of the present invention to provide the method as defined above, wherein each offer of the at least two offers Oᵢ is characterized by an offer-feature-vector OFVᵢ comprising at least one characteristic selected from a group consisting of: PayIn PIᵢ, countries, categories, optional-banner-size, optional-banner-location, optional-banner-orientation, optional-exposure-period, optional-exposure-time, optional-ages, optional-gender, optional-education, optional-user's-income, optional-user's-profession, estimated-CTR, estimated-CR and at least one banner.

It is another object of the present invention to provide the method as defined above, further comprising real-time step of calculating bidding-price BP for the selected the optimal-offer, based on at least one characteristic selected from a group consisting of: the PayIn of the optimal-offer, the estimated-CTRs of the optimal-offer, the estimated-CRs of the optimal-offer and any combination thereof.

It is another object of the present invention to provide the method as defined above, further comprising real-time step of calculating at least two bidding-prices BPᵢ each for different offer of the at least two offers Oᵢ, based on at least one characteristic selected from a group consisting of: the PayIn PIᵢ, the estimated-CTRs ECTRᵢ, the estimated-CRs ECRᵢ and any combination thereof.

It is another object of the present invention to provide the method as defined above, further comprising real-time step filtering out at least one offer of the at least two offers Oᵢ, incase the bidding-price of the offer is lower than a predetermined price-floor.

It is another object of the present invention to provide the method as defined above, wherein the step of selecting the optimal-offer is according to at least one characteristic selected from a group consisting of: highest the score Sᵢ, highest the estimated-CTR ECTRᵢ, highest the estimated-CRs ECRᵢ, lowest the bidding-price BPᵢ, highest bidding-price BPᵢ, maximum revenue and any combination thereof.

It is another object of the present invention to provide the method as defined above, further comprising an offline step of providing the method with at least one database selected from a group consisting of: offers-database [210], impressions-database [220], clicks-database [230], CTR-database [240], conversions-database [250], requests-database [260], users-database [270], biddings-database [280], and hash-table features [290].

It is another object of the present invention to provide the method as defined above, further comprising an offline or near real-time step of calculating the at least two first-weight-vectors W1ᵢ, calculated based on at least one W1-database selected from a group consisting of: the offers-database [210], the impressions-database [220], the clicks-database [230], the CTR-database [240], the conversions-database [250], the requests-database [260], the users-database [270], the biddings-database [280], hash table features [290], and any combination thereof.

It is another object of the present invention to provide the method as defined above, further comprising step of aggregating the W1-database, according to a learning rate η₁.

It is another object of the present invention to provide the method as defined above, further comprising step of periodically aggregating the W1-database per a time-period selected from a group consisting of: millisecond, second, minute, hour, day, week, month, year and any combination thereof.

It is another object of the present invention to provide the method as defined above, further comprising a real-time step of calculating the at least two second-weight-vectors W2ᵢ, calculated based on at least one W2-database selected from a group consisting of: the offers-database [210], the impressions-database [220], the clicks-database [230], the CTR-database [240], the conversions-database [250], the requests-database [260], the users-database [270], the biddings-database [280], hash table features [290], and any combination thereof.

It is another object of the present invention to provide the method as defined above, further comprising step of aggregating the W2-database, according to a learning rate η₂.

It is another object of the present invention to provide the method as defined above, further comprising step of periodically aggregating the W2-database per time-period selected from a group consisting of: millisecond, second, minute, hour, day, week, month, year and any combination thereof.

It is another object of the present invention to provide the method as defined above, wherein the step of calculating the at least two estimated-CTRs ECTRᵢ uses methods of logistic regression.

It is another object of the present invention to provide the method as defined above, wherein the step of calculating the at least two estimated-CRs ECRᵢ uses methods of logistic regression.

It is another object of the present invention to provide the method as defined above, further comprising real-time step of receiving at least one the request.

It is another object of the present invention to provide the method as defined above, further comprising real-time step of submitting the optimal-offer towards the at least one incoming request.

It is another object of the present invention to provide the method as defined above, wherein the request-context-vector is a sparse vector.

It is another object of the present invention to provide the method as defined above, wherein the first-weight-vector W1ᵢ and/or the second-weight-vector W2ᵢ is a sparse vector.

It is another object of the present invention to provide the method as defined above, wherein the request-context-vector is a context vector.

It is another object of the present invention to provide the method as defined above, further comprising real-time step of indexing, by means of filtering out, at least one offer of the at least two offers Oᵢ, according to restrictions set by the request-feature-vector.

It is another object of the present invention to provide the method as defined above, wherein the step of parsing the at least one request is according to a features' Hash-table.

It is another object of the present invention to provide the method as defined above, further comprising step of displaying the selected the optimal-offer.

It is another object of the present invention to provide the method as defined above, wherein the real-time steps a-e are configured for big data scale.

It is another object of the present invention to provide the method as defined above, further comprising at least one real-time step selected from a group consisting of:
a. collecting the offers-database [210];
b. collecting impressions-database [220] of the at least one selected optimal offer;
c. collecting the clicks-database [230] of the at least one selected optimal offer;
d. collecting the CTR-database [240];
e. collecting the conversions-database [250] of the at least one selected optimal offer;
f. collecting the requests-database [260];
g. collecting the users-database [270]; and
h. collecting the biddings-database [280].

It is another object of the present invention to provide the method as defined above, wherein the request-context-vector comprising at least one characteristic selected from a group consisting of: network data, geographical-performance, ad-latency, requested-price, initial-bidding-price, platform (operating system), carrier, country, banner-size, banner-location, banner-orientation, target-age, target-gender, target-intellect, target-income target-profession, exposure-period and exposure-time, price-floor, and any combination thereof.

It is another object of the present invention to provide the method as defined above, further comprising step of identifying at least one user designated for the request.

It is another object of the present invention to provide the method as defined above, wherein the at least one user is characterized a profiling-contextual-vector comprising at least one characteristic selected from a group consisting of: location, gender, income, education, profession, age, favorite categories, former impressions, former clicks, former conversions, favorite categories, restricted categories, and any combination thereof.

It is another object of the present invention to provide the method as defined above, further comprising real-time step of indexing, by means of filtering out, at least one offer of the at least two offers Oᵢ, according to at least on characteristic selected from a group consisting of: restrictions set by the request-feature-vector, the user's former impressions, the user's former clicks, the user's former conversions, the user's categories restrictions and any combination thereof.

It is another object of the present invention to provide the method as defined above, wherein the step of calculating the at least two estimated-CTRs ECTRᵢ is further based of the at least one user's profiling-contextual-vector.

It is another object of the present invention to provide the method as defined above, wherein the step of calculating the at least two estimated-CRs ECRᵢ is further based of the at least one user's profiling-contextual-vector.

It is another object of the present invention to provide the method as defined above, wherein the step of parsing is conducted off-line or near real-time.

It is another object of the present invention to provide the method as defined above, further comprising step of selecting optimal-banner from the at least one banner, for the optimal-offer.

It is another object of the present invention to provide the method as defined above, further comprising the step of selecting an optimal-banner out of the at least one banner, based on the at least one B-database selected from a group consisting of: the clicks-database [230], the CTR-database [240] and the conversions-database [250].

It is another object of the present invention to provide a real-time selection system [100] for selecting an optimal-offer out of at least two offers O_{i,i=1 . . . N≧2}, set towards at least one incoming request; the system [100] comprising processor [110] configured to control operation of the selection by means of:
a. parse the at least one request to a request-context-vector;
b. calculate at least two estimated-CTRs ECTRᵢ, each for different offer of the at least two of offers Oᵢ, based on the request-context-vector and at least two first-weight-vectors W1ᵢ each configured for different offer of the at least two offers Oᵢ;
c. calculate at least two estimated-CRs ECRᵢ each for different offer of the at least two of offers Oᵢ, based on the request-context-vector and at least two second-weight-vectors W2ᵢ each configured for different offer of the at least two offers Oᵢ;
d. calculate at least two scores Sᵢ each for different offer of the at least two offers Oᵢ, based on the at least two estimated-CTRs ECTRᵢ and the at least two estimated-CRs ECRᵢ;
e. calculate a choosing-probability Pᵢ for each offer of the at least two offers Oᵢ, based on the score Sᵢ; and
f. select the optimal-offer;
wherein calculation of the at least two estimated-CTRs and calculation of the least two estimated-CRs are based on at least one previously selected the optimal-offer.

It is another object of the present invention to provide the system as defined above, wherein selection of the optimal-offer is according to at least one characteristic selected from a group consisting of: highest the score Sᵢ, highest the estimated-CTR ECTRᵢ, highest the estimated-CRs ECRᵢ, highest the choosing probability Pᵢ, lowest the choosing probability Pᵢ, random of the choosing probability Pᵢ and any combination thereof.

It is another object of the present invention to provide the system as defined above, wherein each offer of the at least two offers Oᵢ is characterized by an offer-feature-vector OFVᵢ comprising at least one characteristic selected from a group consisting of: PayIn PIᵢ, countries, categories, optional-banner-size, optional-banner-location, optional-banner-orientation, optional-exposure-period, optional-exposure-time, optional-ages, optional-gender, optional-education, optional-user's-income, optional-user's-profession, estimated-CTR, estimated-CR and at least one banner.

It is another object of the present invention to provide the system as defined above, wherein the processor [110] further configured for real-time calculation of bidding-price BP for the selected the optimal-offer, based on at least one characteristic selected from a group consisting of: the PayIn of the optimal-offer, the estimated-CTRs of the optimal-offer, the estimated-CRs of the optimal-offer and any combination thereof.

It is another object of the present invention to provide the system as defined above, wherein the processor [110] further configured for real-time calculation of at least two bidding-prices BPᵢ each for different offer of the at least two offers Oᵢ, based on at least one characteristic selected from a group consisting of: the PayIn PIᵢ, the estimated-CTRs ECTRᵢ, the estimated-CRs ECRᵢ and any combination thereof.

It is another object of the present invention to provide the system as defined above, wherein the processor [110] further configured for real-time filtering out of at least one offer of the at least two offers Oᵢ, incase the bidding-price of the offer is lower than a predetermined price-floor.

It is another object of the present invention to provide the system as defined above, wherein the selection of the optimal-offer is according to at least one characteristic selected from a group consisting of: highest the score Sᵢ, highest the estimated-CTR ECTRᵢ, highest the estimated-CRs ECRᵢ, lowest the bidding-price BPᵢ, highest bidding-price BPᵢ, maximum revenue and any combination thereof.

It is another object of the present invention to provide the system as defined above, further comprising at least one database selected from a group consisting of: offers-database [210], impressions-database [220], clicks-database [230], CTR-database [240], conversions-database [250], requests-database [260], users-database [270], biddings-database [280], and hash-table features [290].

It is another object of the present invention to provide the system as defined above, wherein the processor [110] further configured for an offline or near real-time calculation of the at least two first-weight-vectors W1ᵢ, based on at least one W1-database selected from a group consisting of: the offers-database [210], the impressions-database [220], the clicks-database [230], the CTR-database [240], the conversions-database [250], the requests-database [260], the users-database [270], the biddings-database [280], hash table features [290], and any combination thereof.

It is another object of the present invention to provide the system as defined above, wherein the processor [110] further configured to aggregate the W1-database, according to a learning rate η₁.

It is another object of the present invention to provide the system as defined above, wherein the processor [110] further configured to periodically aggregate the W1-database per a time-period selected from a group consisting of: millisecond, second, minute, hour, day, week, month, year and any combination thereof.

It is another object of the present invention to provide the system as defined above, wherein the processor [110] further configured for real-time calculation of the at least two second-weight-vectors W2ᵢ, based on at least one W2-database selected from a group consisting of: the offers-database [210], the impressions-database [220], the clicks-database [230], the CTR-database [240], the conversions-database [250], the requests-database [260], the users-database [270], the biddings-database [280], hash table features [290], and any combination thereof.

It is another object of the present invention to provide the system as defined above, wherein the processor [110] further configured to aggregate the W2-database, according to a learning rate η₂.

It is another object of the present invention to provide the system as defined above, wherein the processor [110] further configured to periodically aggregate the W2-database per time-period selected from a group consisting of: millisecond, second, minute, hour, day, week, month, year and any combination thereof.

It is another object of the present invention to provide the system as defined above, wherein the calculation of the at least two estimated-CTRs ECTRᵢ uses methods of logistic regression.

It is another object of the present invention to provide the system as defined above, wherein the calculation of the at least two estimated-CRs ECRᵢ uses methods of logistic regression.

It is another object of the present invention to provide the system as defined above, wherein the request-context-vector is a sparse vector.

It is another object of the present invention to provide the system as defined above, wherein the first-weight-vector W1ᵢ and/or the second-weight-vector W2ᵢ is a sparse vector.

It is another object of the present invention to provide the system as defined above, wherein the request-context-vector is a context vector.

It is another object of the present invention to provide the system as defined above, wherein the processor [110] further configured for real-time indexing, by means of filtering out, at least one offer of the at least two offers Oᵢ, according to restrictions set by the request-feature-vector.

It is another object of the present invention to provide the system as defined above, wherein parsing of the at least one request is according to a features' Hash-table.

It is another object of the present invention to provide the system as defined above, wherein the processor [110] further configured for processing big data scale.

It is another object of the present invention to provide the system as defined above, wherein the request-context-vector comprising at least one characteristic selected from a group consisting of: network data, geographical-performance, ad-latency, requested-price, initial-bidding-price, platform (operating system), carrier, country, banner-size, banner-location, banner-orientation, target-age, target-gender, target-intellect, target-income target-profession, exposure-period and exposure-time, price-floor, and any combination thereof.

It is another object of the present invention to provide the system as defined above, wherein the processor [110] further configured to identify at least one user designated for the request.

It is another object of the present invention to provide the system as defined above, wherein the at least one user is characterized a profiling-contextual-vector comprising at least one characteristic selected from a group consisting of: location, gender, income, education, profession, age, favorite categories, former impressions, former clicks, former conversions, favorite categories, restricted categories, and any combination thereof.

It is another object of the present invention to provide the system as defined above, wherein the processor [110] further configured for real-time indexing, by means of filtering out, at least one offer of the at least two offers Oᵢ, according to at least on characteristic selected from a group consisting of: restrictions set by the request-feature-vector, the user's former impressions, the user's former clicks, the user's former conversions, the user's categories restrictions and any combination thereof.

It is another object of the present invention to provide the system as defined above, wherein the calculation of the at least two estimated-CTRs ECTRᵢ is further based of the at least one user's profiling-contextual-vector.

It is another object of the present invention to provide the system as defined above, wherein the calculation of the at least two estimated-CRs ECRᵢ is further based of the at least one user's profiling-contextual-vector.

It is another object of the present invention to provide the system as defined above, wherein the parsing is conducted off-line or near real-time.

It is another object of the present invention to provide the system as defined above, wherein the processor [110] further configured to select optimal-banner from the at least one banner, for the optimal-offer.

It is still an object of the present invention to provide the system as defined above, wherein the processor [110] further configured to select an optimal-banner out of the at least one banner, based on the at least one B-database selected from a group consisting of: the clicks-database [230], the CTR-database [240] and the conversions-database [250].

It is lastly an another object of the present invention to provide the system as defined above, wherein the processor [110] is embedded in at least one entity selected from a group consisting of: computer, smart-phone, laptop, tablet and any combination thereof.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1: presents an illustrated diagram describing the real-time selection system;

FIG. 2: presents an illustrated diagram describing the real-time selection method; and

FIG. 3: presents an illustrated diagram describing the real-time selection method, with an identified user.

### DETAILED DESCRIPTION OF PREFERRED EMBODIMENTS

The following description is provided, alongside all chapters of the present invention, so as to enable any person skilled in the art to make use of the invention and sets forth the best modes contemplated by the inventor of carrying out this invention. Various modifications, however, is adapted to remain apparent to those skilled in the art, since the generic principles of the present invention have been defined specifically to provides a system and method for real-time optimal offer selection.

The term “Click Through Rate” (CTR), used herein, refers to a way of measuring the success of an online advertising campaign for a particular website, mobile application, or web application, as well as the effectiveness of an email campaign by the rate in which users click on a specific link.

The term “Conversion”, used herein, refers to describe the act of converting website, mobile application, or web application user into paying user and/or by means of download of the application. Although different website, mobile application, or web application may consider a “conversion” to be some sort of result other than a sale.

The term “Impression”, used herein, refers to the context of online advertising, by means of the measure of the number of times an ad is displayed, whether it is clicked on or not. Each time an ad displays it is counted as one impression.

The term “Big data”, used herein, is a term for collection of data sets so large and complex that it becomes difficult to process using on-hand database management tools or traditional data processing applications. The challenges of big data include capture, curation, storage, search, sharing, transfer, analysis, and visualization.

The terms “Sparse matrix” and “Sparse vector”, used herein, refers to the subfield of numerical analysis. A sparse matrix or vector is a matrix or a vector populated primarily with zeros as elements of the table. The fraction of zero elements in a matrix is referred as “sparsity”.

The term “Feature hashing” or “Context hashing”, used herein, refers to the field of machine learning. Feature/Context hashing is a fast and space-efficient way of vectorizing features, i.e. turning arbitrary features into indices in a vector or matrix. It works by applying a hash function to the features and using their hash values as indices directly, rather than looking the indices up in looking the indices up in an associative array.

The term “Ad-exchange”, used herein, refers to technology platforms (Like MoPub™) that facilitate bidded buying and selling of online media advertising inventory from multiple ad networks.

The term “Publisher”, used herein, refers to any website or mobile application or webapp publisher such as but not limited to search engines (Google™), news (Ynet™), sales (eBay™), social-networks (Facebook™, Whatup™), banking, any publisher who allocates an advertising ad on its' web or application page.

The term “Request”, used herein, refers to a publisher's information regarding a bidding selection for an available advertising option (which may be an interactive), the features of the request can include, but are not limited to: user-provided data, network data, geographical performance, ad latency, historical performance, requested-price (or a bidding start-price), platform (operating system), carrier, country, banner-size, banner-location, potential-viewers (age, gender, intellect, income and profession), exposure-period and exposure-time.

The term “Offer”, used herein, refers to the potential buyer/advertiser for the proposed request, which may be offered via an ad-exchange such as but not limited to MoPub™. The offer's features include the advertiser's interest such as but not limited to: platform (operating system), carrier, country, banner-size, banner-location, potential-viewers (age, gender, intellect, income, and profession), exposure-period and exposure-time. An advertiser may submit more than one offer.

The term “User”, used herein, refers to any potential customer's device having an IP address (a numerical label assigned to devices, e.g., computer, mobile) participating in a network that uses the Internet Protocol for communication. The features of a user can include but are not limited to: platform (operating system), carrier, country, age, gender, intellect, income, profession, history of online activities (searches, clicks, purchases).

The term “Cost per Millennial impressions, CPM”, used herein, refers to the cost that advertisers pay each time an ad is displayed in unites of 1000 impressions. Specifically, it is the cost or expense incurred for marketing potential customers who view the advertisement(s).

The term “Real-time bidding (RTB)”, used herein, refers to the means by which ad inventory is bought and sold on a per-impression basis, via programmatic instantaneous auction, similar to financial markets. With real-time bidding, advertising buyers bid on an impression and, if the bid is won, the buyer's ad is instantly displayed on the publisher's site.

The term “PayIn”, used herein, refers to the price that an offer's advertiser pays for every actual click and/or every actual conversion after winning the bid.

The term “Price-floor”, used herein, refers to a suggested bidding price, which an offer should rise above.

The term “Indexing”, used herein, refers to filtering offers according to publisher limits or restrictions such as but not limited to: an advertiser origin, ad categories; or filtering according to the users' former activity, such as but not limited to: former exposure to advertiser ad, former impressions, clicks and or conversions.

The term “logistic regression” refers to a type of probabilistic statistical classification model. It is used for estimating empirical values of the parameters in a qualitative response model. The probabilities describing the possible outcomes of a single trial are modeled, as a function of the explanatory (predictor) variables, using a logistic function. Logistic regression measures the relationship between a categorical dependent variable and one or more independent variables, which are usually (but not necessarily) continuous, by using probability scores as the predicted values of the dependent variable.

The term “Parsing” or “Syntactic analysis” used herein, refers to the process of analyzing a string of symbols, either in natural language or in computer languages, and translating or mapping those symbols into pre-defined set of features.

The present invention provides a method for real-time selection of optimal-offer out of at least two competitive offers O_{i,i=1 . . . N≧2}, set towards at least one incoming request; the method comprising real-time steps of:
a. providing a processor [110], configured for controlling operation of said selection;
b. parsing the at least one request to a request-context-vector;
c. calculating at least two estimated-CTRs ECTRᵢ, each for different offer of the at least two of offers Oᵢ, based on the request-context-vector and at least two first-weight-vectors W1ᵢ each configured for different offer of the at least two offers Oᵢ;
d. calculating at least two estimated-CRs ECRᵢ each for different offer of the at least two of offers Oᵢ, based on the request-context-vector and at least two second-weight-vectors W2ᵢ each configured for different offer of the at least two offers Oᵢ;
e. calculating at least two scores Sᵢ each for different offer of the at least two offers Oᵢ, based on the at least two estimated-CTRs ECTRᵢ and the at least two estimated-CRs ECRᵢ;
f. calculating a choosing-probability Pᵢ for each offer of the at least two offers Oᵢ, based on the score Sᵢ;
g. selecting the optimal-offer;
   wherein the steps of calculating at least two estimated-CTRs and calculating at least two estimated-CRs are based on at least one previously selected the optimal-offer.

The present invention further provides a real-time selection system [100] for selecting an optimal-offer out of at least two offers O_{i,i=1 . . . N≧2}, set towards at least one incoming request; the system [100] comprising a processor [110] configured to control operation of the selection by means of:
a. parse the at least one request to a request-context-vector;
b. calculate at least two estimated-CTRs ECTRᵢ, each for different offer of the at least two of offers Oᵢ, based on the request-context-vector and at least two first-weight-vectors W1ᵢ each configured for different offer of the at least two offers Oᵢ;
c. calculate at least two estimated-CRs ECRᵢ each for different offer of the at least two of offers Oᵢ, based on the request-context-vector and at least two second-weight-vectors W2ᵢ each configured for different offer of the at least two offers Oᵢ;
d. calculate at least two scores Sᵢ each for different offer of the at least two offers Oᵢ, based on the at least two estimated-CTRs ECTRᵢ and the at least two estimated-CRs ECRᵢ;
e. calculate a choosing-probability Pᵢ for each offer of the at least two offers Oᵢ, based on the score Sᵢ; and
f. select the optimal-offer;
wherein calculation of the at least two estimated-CTRs and calculation of the least two estimated-CRs are based on at least one previously selected the optimal-offer.

According to an embodiment of the present invention, the step of selecting the optimal-offer is according to at least one characteristic selected from a group consisting of: highest the score Sᵢ, highest the estimated-CTR ECTRᵢ, highest the estimated-CRs ECRᵢ, highest the choosing probability Pᵢ, lowest the choosing probability Pᵢ, random of the choosing probability Pᵢ and any combination thereof.

According to another embodiment of the present invention, each offer of the at least two offers Oᵢ is characterized by an offer-feature-vector OFVᵢ comprising at least one characteristic selected from a group consisting of: PayIn PIᵢ, countries, categories, optional-banner-size, optional-banner-location, optional-banner-orientation, optional-exposure-period, optional-exposure-time, optional-ages, optional-gender, optional-education, optional-user's-income, optional-user's-profession, estimated-CTR, estimated-CR and at least one banner.

According to another embodiment of the present invention, the method further comprising real-time step of calculating bidding-price BP for the selected the optimal-offer, based on at least one characteristic selected from a group consisting of: the PayIn of the optimal-offer, the estimated-CTRs of the optimal-offer, the estimated-CRs of the optimal-offer and any combination thereof.

According to another embodiment of the present invention, the method further comprising real-time step of calculating at least two bidding-prices BPᵢ each for different offer of the at least two offers Oᵢ, based on at least one characteristic selected from a group consisting of: the PayIn PIᵢ, the estimated-CTRs ECTRᵢ, the estimated-CRs ECRᵢ and any combination thereof.

According to another embodiment of the present invention, the method further comprising real-time step filtering out at least one offer of the at least two offers Oᵢ, incase the bidding-price of the offer is lower than a predetermined price-floor, set by the request or by a third party.

According to another embodiment of the present invention, the step of selecting the optimal-offer is according to at least one characteristic selected from a group consisting of: highest the score Sᵢ, highest the estimated-CTR ECTRᵢ, highest the estimated-CRs ECRᵢ, lowest the bidding-price BPᵢ, highest bidding-price BPᵢ, maximum revenue and any combination thereof.

According to another embodiment of the present invention, the method further comprising an offline step of providing the method with at least one database selected from a group consisting of: offers-database [210], impressions-database [220], clicks-database [230], CTR-database [240], conversions-database [250], requests-database [260], users-database [270], biddings-database [280], and hash-table features [290].

According to another embodiment of the present invention, the method further comprising an offline or near real-time step of calculating the at least two first-weight-vectors W1ᵢ, calculated based on at least one W1-database selected from a group consisting of: the offers-database [210], the impressions-database [220], the clicks-database [230], the CTR-database [240], the conversions-database [250], the requests-database [260], the users-database [270], the biddings-database [280], hash table features [290], and any combination thereof.

According to another embodiment of the present invention, the method further comprising step of aggregating the W1-database, according to a learning rate r.

According to another embodiment of the present invention, the method comprising step of periodically aggregating the W1-database per a time-period selected from a group consisting of: millisecond, second, minute, hour, day, week, month, year and any combination thereof.

According to another embodiment of the present invention, the method further comprising a real-time step of calculating the at least two second-weight-vectors W2ᵢ, calculated based on at least one W2-database selected from a group consisting of: the offers-database [210], the impressions-database [220], the clicks-database [230], the CTR-database [240], the conversions-database [250], the requests-database [260], the users-database [270], the biddings-database [280], hash table features [290], and any combination thereof.

According to another embodiment of the present invention, the method further comprising step of aggregating the W2-database, according to a learning rate η₂.

According to another embodiment of the present invention, the method further comprising step of periodically aggregating the W2-database per time-period selected from a group consisting of: millisecond, second, minute, hour, day, week, month, year and any combination thereof.

According to another embodiment of the present invention, the step of calculating the at least two estimated-CTRs ECTRᵢ uses methods of logistic regression.

According to another embodiment of the present invention, the step of calculating the at least two estimated-CRs ECRᵢ uses methods of logistic regression.

According to another embodiment of the present invention, the method further comprising real-time step of receiving at least one the request.

According to another embodiment of the present invention, the method further comprising real-time step of submitting the optimal-offer towards the at least one incoming request.

According to another embodiment of the present invention, the request-context-vector is a sparse vector.

According to another embodiment of the present invention, the first-weight-vector W1ᵢ and/or the second-weight-vector W2ᵢ is a sparse vector.

According to another embodiment of the present invention, the request-context-vector is a context vector.

According to another embodiment of the present invention, the method further comprising real-time step of indexing, by means of filtering out, at least one offer of the at least two offers Oᵢ, according to restrictions set by the request-feature-vector.

According to another embodiment of the present invention, the step of parsing the at least one request is according to a features' Hash-table.

According to another embodiment of the present invention, the method further comprising step of displaying the selected optimal-offer.

According to another embodiment of the present invention, the real-time steps a-e are configured for big data scale.

According to another embodiment of the present invention, the method further comprising at least one real-time step selected from a group consisting of:
a. collecting the offers-database [210];
b. collecting impressions-database [220] of the at least one selected optimal offer;
c. collecting the clicks-database [230] of the at least one selected optimal offer;
d. collecting the CTR-database [240];
e. collecting the conversions-database [250] of the at least one selected optimal offer;
f. collecting the requests-database [260];
g. collecting the users-database [270]; and
h. collecting the biddings-database [280].

According to another embodiment of the present invention, the request-context-vector comprising at least one characteristic selected from a group consisting of: network data, geographical-performance, ad-latency, requested-price, initial-bidding-price, platform (operating system), carrier, country, banner-size, banner-location, banner-orientation, target-age, target-gender, target-intellect, target-income target-profession, exposure-period and exposure-time, price-floor, and any combination thereof.

According to another embodiment of the present invention, the method further comprising step of identifying at least one user designated for the request.

According to another embodiment of the present invention, the at least one user is characterized a profiling-contextual-vector comprising at least one characteristic selected from a group consisting of: location, gender, income, education, profession, age, favorite categories, former impressions, former clicks, former conversions, favorite categories, restricted categories, and any combination thereof.

According to another embodiment of the present invention, the method further comprising real-time step of indexing, by means of filtering out, at least one offer of the at least two offers Oᵢ, according to at least on characteristic selected from a group consisting of: restrictions set by the request-feature-vector, the user's former impressions, the user's former clicks, the user's former conversions, the user's categories restrictions and any combination thereof.

According to another embodiment of the present invention, the step of calculating the at least two estimated-CTRs ECTRᵢ is further based of the at least one user's profiling-contextual-vector.

According to another embodiment of the present invention, the step of calculating the at least two estimated-CRs ECRᵢ is further based of the at least one user's profiling-contextual-vector.

According to another embodiment of the present invention, the step of parsing is conducted off-line or near real-time.

According to another embodiment of the present invention, the method further comprising step of selecting optimal-banner from the at least one banner, for the optimal-offer.

According to another embodiment of the present invention, the method further comprising the step of selecting an optimal-banner out of the at least one banner, based on the at least one B-database selected from a group consisting of: the clicks-database [230], the CTR-database [240] and the conversions-database [250].

According to an embodiment of the present invention, the above mentioned method and system are configured to comply with the commercial “OpenRTB 2.x” standard.

The present invention, according to another embodiment, reduces the RTB problem into an optimization problem, where expected revenue is maximized for each displayed impression.

The revenue expectation is calculated as:

E[revenue]=P(bid_won;Price)*[P(click)*P(conversion)*PayIn−Price] Eq. 1:

The expression, as in Eq. 1, allows a numerical computation for the optimal bidding-price, for an impression. According to an embodiment of the present invention a novel solution is proposed, to reduce the solution of the revenue expectation into three independent estimation problems:
(a) estimating P(bid won; price)
(b) estimating P(click,) or in other words CTR
(c) estimating P(conversion), or in other words CR

Items (b) and (c) are solved by the FTRL-Proximal algorithm (Follow the Proximally Regularized Leader), as described in McMahan et al.

According to another embodiment of the present invention, the estimation of item (a) is solved by an original adaptive algorithm with a learning step based on a “weighted” polynomial fitting algorithm.

According to another embodiment of the present invention, the polynomial fitting is defined as follows:

For each price p(i) i=1 . . . ?, a value v(i) is computed from the last X minutes:

v(i)=inv_logistic_function[λ*P(i−1)+(1×λ)*P(i)]

where:
P (i−1) is the previous P(bid_won; Price),
P(i) is the current P(bid_won; Price),
inv_logistic_fun is the standard inverse logistic function,
λ is a value depending on the standard deviation STD of P(i), which depends on the number of impressions bought between states;
then a polynomial fit on the curve p(i),v(i) is computed for different prices p(i).

After obtaining all estimation (a)-(c), the expected revenues of each offer for a specific request, are used as weights Wᵢ configured to choose the optimal offer and then one of its suggested banners, by using a Multi-Arm Bandit (MAB) algorithm, as in Auer Exp3 first step. However, Auer's weights Wᵢ are replaced, according to an embodiment of the preset invention, with the expected revenue of each offer, thereby market changes are explored, for an exploration-exploitation trade-off.

$$Algorithm Exp3 Parameters \text{:} Real γ ∈ ( 0 , 1 ] . \\ Initialization \text{:} {ω}_{i} ( 1 ) = 1 for i = 1 , … , K . \\ For each t = 1 , 2 , … 1. Set \\ {p}_{i} ( t ) = ( 1 - γ ) \frac{{ω}_{i} ( t )}{{\sum }_{j = 1}^{K} {ω}_{j} ( t )} + \frac{γ}{K} \\ i = 1 , … , K .$$

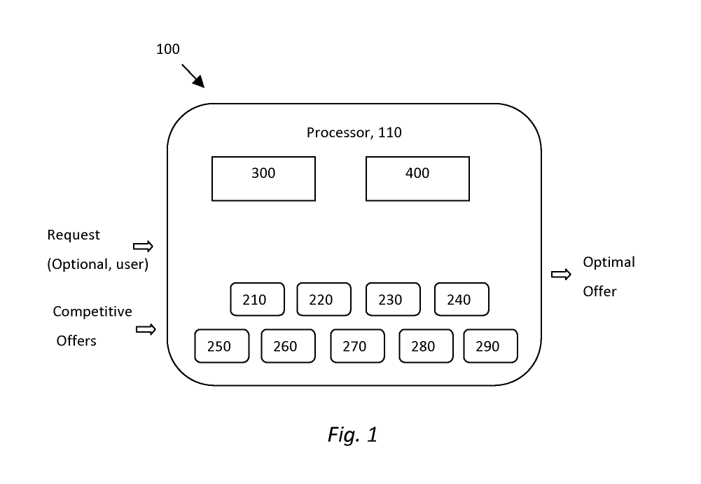

Auer et al. (FIG. 1 Exp3)

Reference is now made to FIG. 1, disclosing the real-time selection system [100] for selecting an optimal-offer out of at least two competitive offers O_{i,i=1 . . . N≧2}, set towards at least one incoming request. The system [100] comprises a processor [110] and a database selected from a group consisting of: offers-database [210], impressions-database [220], clicks-database [230], CTR-database [240], conversions-database [250], requests-database [260], users-database [270], biddings-database [280], and hash-table features [290].

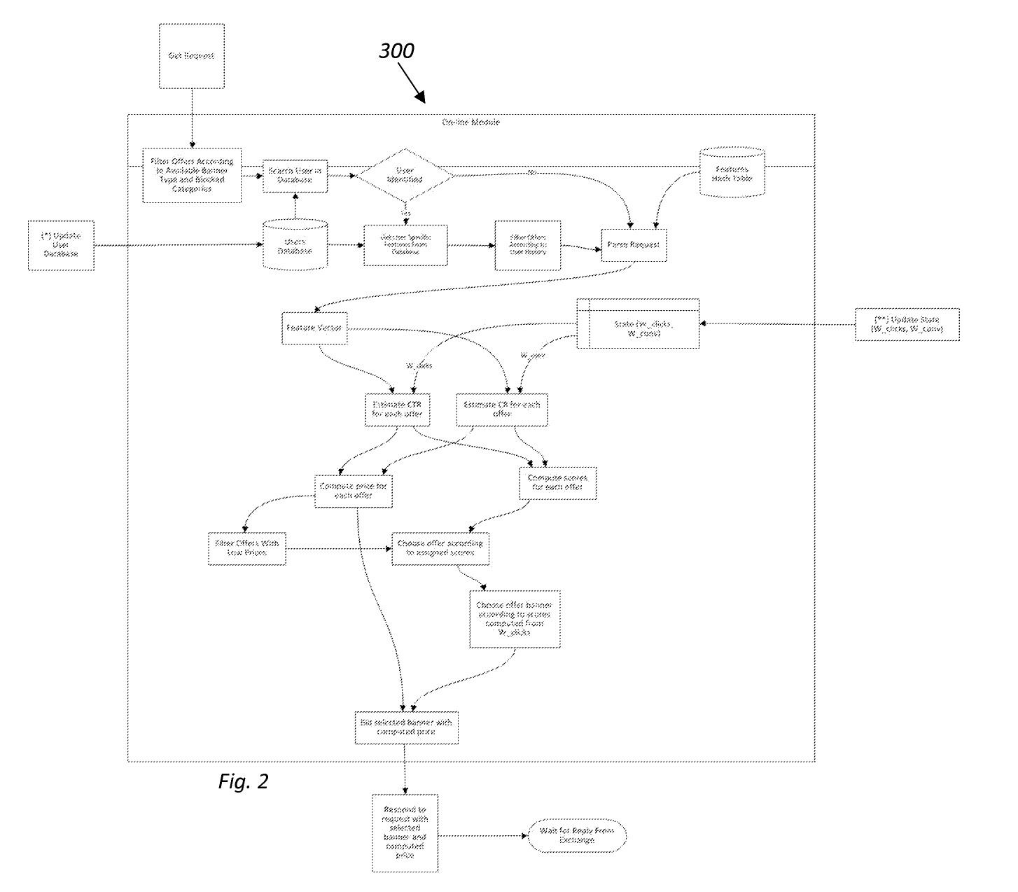

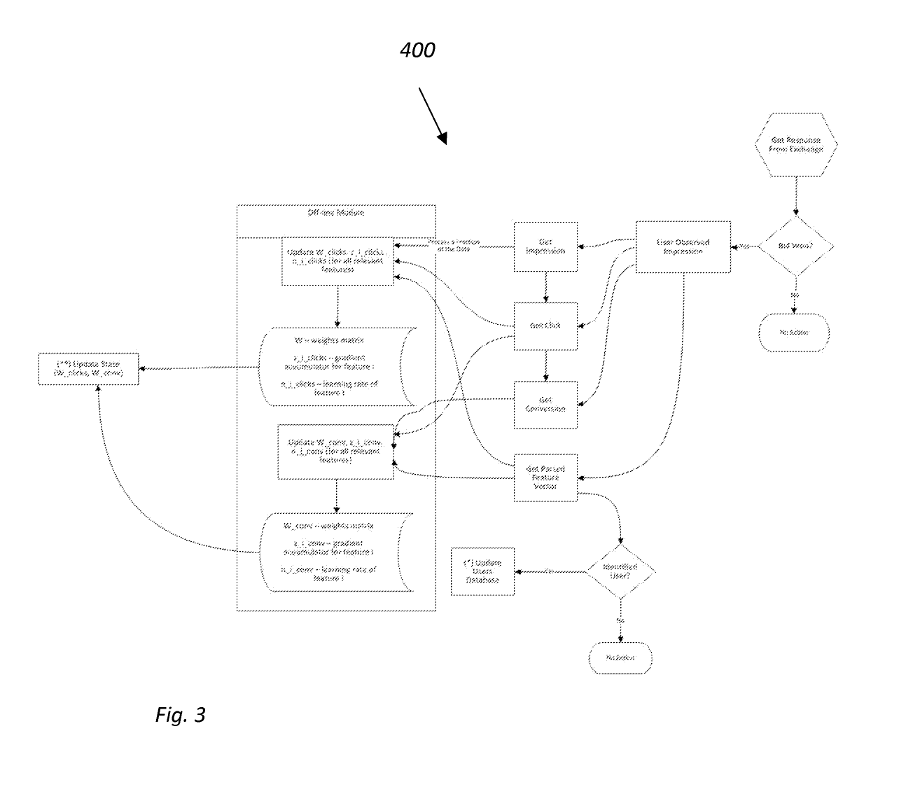

Reference is now made to FIGS. 2 and 3, disclosing an illustrated diagram describing the selection method modules including the real-time module [300] and the off-line module [400] connected in two places marked with (*) and (**), in both figures.

FIG. 2 discloses an illustrated diagram describing the real-time module [300] of the selection method with the combined steps mentioned above. As demonstrated in the first step a request is collected from the exchange and accordingly in the following step the competitive offers O_{i,i=1 . . . N} are filtered according to available banner type and blocked categories. In the next step a search is conducted whether the user (receiver of the ad) is known; incase the user is identified a secondary filter is conducted according to the user's known features and interests. In the following step, the request is parsed to a feature vector, by means of context-vector, according to update Hash table features. In the next step estimated-CTRs ECTRᵢ are calculated for each offer, based on the request's context-vector and updated first-weight-vectors W1ᵢ each configured for different offer; in addition estimated-CRs ECRᵢ are calculated for each offer Oᵢ, based on the request's context-vector and updated second-weight-vectors W2ᵢ each configured for different offer. In the following step calculating scores Sᵢ are calculated for each offer, based on its estimated-CTRs ECTRi and its estimated-CRs ECRᵢ; in addition bidding-prices BPᵢ are calculated for each, based on at least one characteristic selected from a group consisting of: the PayIn PIᵢ, the estimated-CTRs ECTRᵢ, the estimated-CRs ECRᵢ and any combination thereof and a third filter is conducted to remove offers which are lower than a predetermined price-floor, set by the request or by a third party. In the following step, after the third filter, an optimal offer is selected according to the best score and accordingly its bid price and an appropriate banner. In the following steps the selected optimal offer is submitted toward the examined request and the respond from the exchange is stored for further updating, as demonstrated in FIG. 3.

FIG. 3 discloses an illustrated diagram describing the off-line module [400] of the selection method with the combined steps as mentioned above. As demonstrated, in the case that the submitted optimal-offer is accepted the receiving user is observed for at least one of the following actions: the actual impressions, the number of clicks and the number of conversions.

The user is further observed for its features and interests, such that a user feature-vector is parsed; in the case that the user is known the users' database is updated. In the following step W1 and W2 are calculated by means of updating and aggregation.

The present invention being thus described in terms of several embodiments and examples, it will be appreciated that the same may be varied in many ways. Such variations are not to be regarded as a departure from the spirit and scope of the invention, and all such modifications as would be obvious to one skilled in the art are contemplated.

What is claimed is:

1. A method for real-time selection of optimal-offer out of at least two offers O_{i,i=1 . . . N≧2}, set towards at least one incoming request; said method comprising real-time steps of:
a. providing a processor [110], configured for controlling operation of said selection;
b. parsing said at least one request to a request-context-vector;
c. calculating at least two estimated-CTRs ECTRᵢ, each for different offer of said at least two of offers Oᵢ, based on said request-context-vector and at least two first-weight-vectors W1ᵢ each configured for different offer of said at least two offers Oᵢ;
d. calculating at least two estimated-CRs ECRᵢ each for different offer of said at least two of offers Oᵢ, based on said request-context-vector and at least two second-weight-vectors W2ᵢ each configured for different offer of said at least two offers Oᵢ;
e. calculating at least two scores Sᵢ each for different offer of said at least two offers Oᵢ, based on said at least two estimated-CTRs ECTRᵢ and said at least two estimated-CRs ECRᵢ;
f. calculating a choosing-probability Pᵢ for each offer of said at least two offers Oᵢ, based on said score Sᵢ; and,
g. selecting said optimal-offer;
wherein said steps of calculating at least two estimated-CTRs and calculating at least two estimated-CRs are based on at least one previously selected said optimal-offer.

2. The method according to claim 1, wherein said step of selecting said optimal-offer is according to at least one characteristic selected from a group consisting of: highest said score Sᵢ, highest said estimated-CTR ECTRᵢ, highest said estimated-CRs ECRᵢ, highest said choosing probability Pᵢ, lowest said choosing probability Pᵢ, random of said choosing probability Pᵢ and any combination thereof.

3. The method according to claim 1, wherein each offer of said at least two offers Oᵢ is characterized by an offer-feature-vector OFVᵢ comprising at least one characteristic selected from a group consisting of: PayIn PIᵢ, countries, categories, optional-banner-size, optional-banner-location, optional-banner-orientation, optional-exposure-period, optional-exposure-time, optional-ages, optional-gender, optional-education, optional-user's-income, optional-user's-profession, estimated-CTR, estimated-CR and at least one banner.

4. The method according to claim 3, additionally comprising at least one of the following real time steps:
a. calculating bidding-price BP for the selected said optimal-offer, based on at least one characteristic selected from a group consisting of: said PayIn of said optimal-offer, said estimated-CTRs of said optimal-offer, said estimated-CRs of said optimal-offer and any combination thereof;
b. calculating at least two bidding-prices BPᵢ each for different offer of said at least two offers Oᵢ, based on at least one characteristic selected from a group consisting of: said PayIn PIᵢ, said estimated-CTRs ECTRᵢ, said estimated-CRs ECRᵢ and any combination thereof;
c. calculating at least two bidding-prices BPᵢ each for different offer of said at least two offers Oᵢ, based on at least one characteristic selected from a group consisting of: said PayIn PIᵢ, said estimated-CTRs ECTRᵢ, said estimated-CRs ECRᵢ and any combination thereof; further wherein filtering out at least one offer of said at least two offers Oᵢ, incase said bidding-price of said offer is lower than a predetermined price-floor;
d. calculating at least two bidding-prices BPᵢ each for different offer of said at least two offers Oᵢ, based on at least one characteristic selected from a group consisting of: said PayIn PIᵢ, said estimated-CTRs ECTRᵢ, said estimated-CRs ECRᵢ and any combination thereof; further wherein filtering out at least one offer of said at least two offers Oᵢ, incase said bidding-price of said offer is lower than a predetermined price-floor; further wherein selecting said optimal-offer is according to at least one characteristic selected from a group consisting of: highest said score Sᵢ, highest said estimated-CTR ECTRᵢ, highest said estimated-CRs ECRᵢ, lowest said bidding-price BPᵢ, highest bidding-price BPᵢ, maximum revenue and any combination thereof;
e. calculating at least two bidding-prices BPᵢ each for different offer of said at least two offers Oᵢ, based on at least one characteristic selected from a group consisting of: said PayIn PIᵢ, said estimated-CTRs ECTRᵢ, said estimated-CRs ECRᵢ and any combination thereof; further wherein selecting said optimal-offer is according to at least one characteristic selected from a group consisting of: highest said score Sᵢ, highest said estimated-CTR ECTRᵢ, highest said estimated-CRs ECRᵢ, lowest said bidding-price BPᵢ, highest bidding-price BPᵢ, maximum revenue and any combination thereof; and,
f. any combination thereof.

5. The method according to claim 3, further comprising at least of the following steps:
a. selecting optimal-banner from said at least one banner, for said optimal-offer;
b. selecting an optimal-banner out of said at least one banner, based on said at least one B-database selected from a group consisting of: said clicks-database [230], said CTR-database [240] and said conversions-database [250]; and,
c. any combination thereof.

6. The method according to claim 1, additionally comprising at least one of the following offline steps:
a. of providing said method with at least one database selected from a group consisting of: offers-database [210], impressions-database [220], clicks-database [230], CTR-database [240], conversions-database [250], requests-database [260], users-database [270], biddings-database [280], and hash-table features [290];
b. providing said method with at least one database selected from a group consisting of: offers-database [210], impressions-database [220], clicks-database [230], CTR-database [240], conversions-database [250], requests-database [260], users-database [270], biddings-database [280], and hash-table features [290]; further wherein an offline or near real-time step of calculating said at least two first-weight-vectors W1ᵢ, calculated based on at least one W1-database selected from a group consisting of: said offers-database [210], said impressions-database [220], said clicks-database [230], said CTR-database [240], said conversions-database [250], said requests-database [260], said users-database [270], said biddings-database [280], hash table features [290], and any combination thereof;
c. providing said method with at least one database selected from a group consisting of: offers-database [210], impressions-database [220], clicks-database [230], CTR-database [240], conversions-database [250], requests-database [260], users-database [270], biddings-database [280], and hash-table features [290]; further wherein an offline or near real-time step of calculating said at least two first-weight-vectors W1ᵢ, calculated based on at least one W1-database selected from a group consisting of: said offers-database [210], said impressions-database [220], said clicks-database [230], said CTR-database [240], said conversions-database [250], said requests-database [260], said users-database [270], said biddings-database [280], hash table features [290], and any combination thereof; further wherein aggregating said W1-database according to a learning rate η₁, periodically aggregating said W1-database per a time-period selected from a group consisting of: millisecond, second, minute, hour, day, week, month, year and any combination thereof, or both;
d. providing said method with at least one database selected from a group consisting of: offers-database [210], impressions-database [220], clicks-database [230], CTR-database [240], conversions-database [250], requests-database [260], users-database [270], biddings-database [280], and hash-table features [290]; further wherein a real-time step of calculating said at least two second-weight-vectors W2ᵢ, calculated based on at least one W2-database selected from a group consisting of: said offers-database [210], said impressions-database [220], said clicks-database [230], said CTR-database [240], said conversions-database [250], said requests-database [260], said users-database [270], said biddings-database [280], hash table features [290], and any combination thereof;
e. providing said method with at least one database selected from a group consisting of: offers-database [210], impressions-database [220], clicks-database [230], CTR-database [240], conversions-database [250], requests-database [260], users-database [270], biddings-database [280], and hash-table features [290]; further wherein a real-time step of calculating said at least two second-weight-vectors W2ᵢ, calculated based on at least one W2-database selected from a group consisting of: said offers-database [210], said impressions-database [220], said clicks-database [230], said CTR-database [240], said conversions-database [250], said requests-database [260], said users-database [270], said biddings-database [280], hash table features [290], and any combination thereof; further wherein at least one step of aggregating said W2 database selected from a group comprising: aggregating said W2-database, according to a learning rate η₂; and, periodically aggregating said W2-database per time-period selected from a group consisting of: millisecond, second, minute, hour, day, week, month, year and any combination thereof, or both; and,
f. any combination thereof.

7. The method according to claim 1, further comprising at least one real-time step of the following:
a. receiving at least one said request;
b. submitting said optimal-offer towards said at least one incoming request;
c. indexing, by means of filtering out, at least one offer of said at least two offers Oᵢ, according to restrictions set by said request-feature-vector; and,
d. any combination thereof.

8. The method according to claim 1, wherein at least one of the following is held true:
a. said step of using methods of logistic regression to calculate said at least two estimated-CTRs ECTRᵢ, said at least two estimated-CRs ECRᵢ, or both;
b. said request-context-vector is selected from a group comprising: a sparse vector, and a context vector;
c. said first-weight-vector W1ᵢ and/or said second-weight-vector W2ᵢ is a sparse vector;
d. said request-context-vector comprising at least one characteristic selected from a group consisting of: network data, geographical-performance, ad-latency, requested-price, initial-bidding-price, platform (operating system), carrier, country, banner-size, banner-location, banner-orientation, target-age, target-gender, target-intellect, target-income target-profession, exposure-period and exposure-time, price-floor, and any combination thereof; and,
e. any combination thereof.

9. The method according to claim 1, additionally comprising at least one of the following steps:
a. parsing said at least one request according to a features' Hash-table;
b. configuring said real-time steps a-e for big data scale;
c. displaying the selected said optimal-offer; and,
d. any combination thereof.

10. The method according to claim 1, additionally comprising the steps of:
a. an offline step of providing said method with at least one database selected from a group consisting of: offers-database [210], impressions-database [220], clicks-database [230], CTR-database [240], conversions-database [250], requests-database [260], users-database [270], biddings-database [280], and hash-table features [290]; and,
b. further comprising at least one real-time step selected from a group consisting of:
i. collecting said offers-database [210];
ii. collecting impressions-database [220] of said at least one selected optimal offer;
iii. collecting said clicks-database [230] of said at least one selected optimal offer;
iv. collecting said CTR-database [240];
v. collecting said conversions-database [250] of said at least one selected optimal offer;
vi. collecting said requests-database [260];
vii. collecting said users-database [270]; and,
viii. collecting said biddings-database [280].

11. The method according to claim 1, additionally comprising at least one of the following steps:
a. identifying at least one user designated for said request;
b. identifying at least one user designated for said request; further wherein characterizing at least one user by a profiling-contextual-vector comprising at least one characteristic selected from a group consisting of: location, gender, income, education, profession, age, favorite categories, former impressions, former clicks, former conversions, favorite categories, restricted categories, and any combination thereof;
c. identifying at least one user designated for said request; further wherein characterizing at least one user by a profiling-contextual-vector comprising at least one characteristic selected from a group consisting of: location, gender, income, education, profession, age, favorite categories, former impressions, former clicks, former conversions, favorite categories, restricted categories, and any combination thereof; further wherein real-time step of indexing, by means of filtering out, at least one offer of said at least two offers Oᵢ, according to at least on characteristic selected from a group consisting of: restrictions set by said request-feature-vector, said user's former impressions, said user's former clicks, said user's former conversions, said user's categories restrictions and any combination thereof;
d. identifying at least one user designated for said request; further wherein characterizing at least one user by a profiling-contextual-vector comprising at least one characteristic selected from a group consisting of: location, gender, income, education, profession, age, favorite categories, former impressions, former clicks, former conversions, favorite categories, restricted categories, and any combination thereof; further wherein utilizing at least one said user's profiling-contextual-vector to calculate: said at least two estimated-CTRs ECTRᵢ, at least two said estimated-CRs ECR_{i,} or both;
e. identifying at least one user designated for said request; further wherein characterizing at least one user by a profiling-contextual-vector comprising at least one characteristic selected from a group consisting of: location, gender, income, education, profession, age, favorite categories, former impressions, former clicks, former conversions, favorite categories, restricted categories, and any combination thereof; further wherein conducting said parsing off-line or near real-time; and,
f. any combination thereof.

12. A real-time selection system [100] for selecting an optimal-offer out of at least two offers O_{i, i=1 . . . N≧2}, set towards at least one incoming request; said system [100] comprising at least one processor [110] configured to control operation of said selection by means of:
a. parse said at least one request to a request-context-vector;
b. calculate at least two estimated-CTRs ECTRᵢ, each for different offer of said at least two of offers Oᵢ, based on said request-context-vector and at least two first-weight-vectors W1ᵢ each configured for different offer of said at least two offers Oᵢ;
c. calculate at least two estimated-CRs ECRᵢ each for different offer of said at least two of offers Oᵢ, based on said request-context-vector and at least two second-weight-vectors W2ᵢ each configured for different offer of said at least two offers Oᵢ;
d. calculate at least two scores Sᵢ each for different offer of said at least two offers Oᵢ, based on said at least two estimated-CTRs ECTRi and said at least two estimated-CRs ECRᵢ;
e. calculate a choosing-probability Pᵢ for each offer of said at least two offers Oᵢ, based on said score Sᵢ; and,
f. select said optimal-offer;
wherein calculation of said at least two estimated-CTRs and calculation of said least two estimated-CRs are based on at least one previously selected said optimal-offer.

13. The system according to claim 12, wherein selection of said optimal-offer is according to at least one characteristic selected from a group consisting of: highest said score Sᵢ, highest said estimated-CTR ECTRᵢ, highest said estimated-CRs ECRᵢ, highest said choosing probability Pᵢ, lowest said choosing probability Pᵢ, random of said choosing probability Pᵢ and any combination thereof.

14. The system according to claim 12, wherein each offer of said at least two offers Oᵢ is characterized by an offer-feature-vector OFVᵢ comprising at least one characteristic selected from a group consisting of: PayIn PIᵢ, countries, categories, optional-banner-size, optional-banner-location, optional-banner-orientation, optional-exposure-period, optional-exposure-time, optional-ages, optional-gender, optional-education, optional-user's-income, optional-user's-profession, estimated-CTR, estimated-CR and at least one banner.

15. The system according to claim 14, wherein at least one of the following is held true:
a. said processor [110] further configured for real-time calculation of bidding-price BP for the selected said optimal-offer, based on at least one characteristic selected from a group consisting of: said PayIn of said optimal-offer, said estimated-CTRs of said optimal-offer, said estimated-CRs of said optimal-offer and any combination thereof;
b. said processor [110] further configured for real-time calculation of at least two bidding-prices BPᵢ each for different offer of said at least two offers Oᵢ, based on at least one characteristic selected from a group consisting of: said PayIn PIᵢ, said estimated-CTRs ECTRᵢ, said estimated-CRs ECRᵢ and any combination thereof;
c. said processor [110] further configured for real-time calculation of at least two bidding-prices BPᵢ each for different offer of said at least two offers Oᵢ, based on at least one characteristic selected from a group consisting of: said PayIn PIᵢ, said estimated-CTRs ECTRᵢ, said estimated-CRs ECRᵢ and any combination thereof; further wherein said processor [110] further configured for real-time filtering out of at least one offer of said at least two offers Oᵢ, incase said bidding-price of said offer is lower than a predetermined price-floor;
d. said processor [110] further configured for real-time calculation of at least two bidding-prices BPᵢ each for different offer of said at least two offers Oᵢ, based on at least one characteristic selected from a group consisting of: said PayIn PIᵢ, said estimated-CTRs ECTRᵢ, said estimated-CRs ECRᵢ and any combination thereof; further wherein said selection of said optimal-offer is according to at least one characteristic selected from a group consisting of: highest said score Sᵢ, highest said estimated-CTR ECTRᵢ, highest said estimated-CRs ECRᵢ, lowest said bidding-price BPᵢ, highest bidding-price BPᵢ, maximum revenue and any combination thereof;
e. said processor [110] further configured for real-time calculation of at least two bidding-prices BPᵢ each for different offer of said at least two offers Oᵢ, based on at least one characteristic selected from a group consisting of: said PayIn PIᵢ, said estimated-CTRs ECTRᵢ, said estimated-CRs ECRᵢ and any combination thereof; further wherein said processor [110] further configured for real-time filtering out of at least one offer of said at least two offers Oᵢ, incase said bidding-price of said offer is lower than a predetermined price-floor; further wherein said selection of said optimal-offer is according to at least one characteristic selected from a group consisting of: highest said score Sᵢ, highest said estimated-CTR ECTRᵢ, highest said estimated-CRs ECRᵢ, lowest said bidding-price BPᵢ, highest bidding-price BPᵢ, maximum revenue and any combination thereof; and,
f. any combination thereof.

16. The system according to claim 14, wherein said processor [110] further configured to select:
a. optimal-banner from said at least one banner, for said optimal-offer;
b. an optimal-banner out of said at least one banner, based on said at least one B-database selected from a group consisting of: said clicks-database [230], said CTR-database [240] and said conversions-database [250]; and,
c. any combination thereof.

17. The system according to claim 12, wherein at least one of the following is held true:
a. said system further comprising at least one database selected from a group consisting of: offers-database [210], impressions-database [220], clicks-database [230], CTR-database [240], conversions-database [250], requests-database [260], users-database [270], biddings-database [280], and hash-table features [290];
b. said system further comprising at least one database selected from a group consisting of: offers-database [210], impressions-database [220], clicks-database [230], CTR-database [240], conversions-database [250], requests-database [260], users-database [270], biddings-database [280], and hash-table features [290]; further, wherein said processor [110] further configured for an offline or near real-time calculation of said at least two first-weight-vectors W1ᵢ, based on at least one W1-database selected from a group consisting of: said offers-database [210], said impressions-database [220], said clicks-database [230], said CTR-database [240], said conversions-database [250], said requests-database [260], said users-database [270], said biddings-database [280], hash table features [290], and any combination thereof;
c. said system further comprising at least one database selected from a group consisting of: offers-database [210], impressions-database [220], clicks-database [230], CTR-database [240], conversions-database [250], requests-database [260], users-database [270], biddings-database [280], and hash-table features [290]; further, wherein said processor [110] further configured for an offline or near real-time calculation of said at least two first-weight-vectors W1ᵢ, based on at least one W1-database selected from a group consisting of: said offers-database [210], said impressions-database [220], said clicks-database [230], said CTR-database [240], said conversions-database [250], said requests-database [260], said users-database [270], said biddings-database [280], hash table features [290], and any combination thereof; further wherein said processor [110] further configured to aggregate said W1-database in a manner selected from: according to a learning rate η₁; periodically aggregate said W1-database per a time-period selected from a group consisting of: millisecond, second, minute, hour, day, week, month, year and any combination thereof; or both;
d. said processor [110] further configured for real-time calculation of said at least two second-weight-vectors W2ᵢ, based on at least one W2-database selected from a group consisting of: said offers-database [210], said impressions-database [220], said clicks-database [230], said CTR-database [240], said conversions-database [250], said requests-database [260], said users-database [270], said biddings-database [280], hash table features [290], and any combination thereof;
e. said system further comprising at least one database selected from a group consisting of: offers-database [210], impressions-database [220], clicks-database [230], CTR-database [240], conversions-database [250], requests-database [260], users-database [270], biddings-database [280], and hash-table features [290]; further wherein said processor [110] further configured to aggregate said W2-database, in a manner selected from: according to a learning rate η₂; periodically aggregate said W2-database per time-period selected from a group consisting of: millisecond, second, minute, hour, day, week, month, year and any combination thereof; or both; and,
f. any combination thereof.

18. The system according to claim 12, wherein at least one of the following is held true:
a. methods of logistic regression are used to calculate said at least two estimated-CTRs ECTRᵢ, said at least two estimated-CRs ECR_{i,} or both;
b. said vector selected from a group comprising: request-context-vector, said first-weight-vector W1ᵢ, said second-weight-vector W2_{i,} and any combination thereof, is a sparse vector;
c. said request-context-vector is a context vector;
d. said request-context-vector comprising at least one characteristic selected from a group consisting of: network data, geographical-performance, ad-latency, requested-price, initial-bidding-price, platform (operating system), carrier, country, banner-size, banner-location, banner-orientation, target-age, target-gender, target-intellect, target-income target-profession, exposure-period and exposure-time, price-floor, and any combination thereof;
e. said processor [110] further configured for real-time indexing, by means of filtering out, at least one offer of said at least two offers Oᵢ, according to restrictions set by said request-feature-vector; and,
f. any combination thereof.

19. The system according to claim 12, wherein at least one of the following is held true:
a. parsing of said at least one request is according to a features' Hash-table;
b. said processor [110] further configured for processing big data scale;
c. said processor [110] is embedded in at least one entity selected from a group consisting of: computer, smart-phone, laptop, tablet and any combination thereof; and,
d. any combination thereof.

20. The system according to claim 12, wherein at least one of the following is held true:
a. said processor [110] further configured to identify at least one user designated for said request;
b. said processor [110] further configured to identify at least one user designated for said request; further wherein said at least one user is characterized a profiling-contextual-vector comprising at least one characteristic selected from a group consisting of: location, gender, income, education, profession, age, favorite categories, former impressions, former clicks, former conversions, favorite categories, restricted categories, and any combination thereof;
c. said processor [110] further configured to identify at least one user designated for said request; further wherein said at least one user is characterized a profiling-contextual-vector comprising at least one characteristic selected from a group consisting of: location, gender, income, education, profession, age, favorite categories, former impressions, former clicks, former conversions, favorite categories, restricted categories, and any combination thereof; further wherein said processor [110] further configured for real-time indexing, by means of filtering out, at least one offer of said at least two offers Oᵢ, according to at least on characteristic selected from a group consisting of: restrictions set by said request-feature-vector, said user's former impressions, said user's former clicks, said user's former conversions, said user's categories restrictions and any combination thereof;
d. said processor [110] further configured to identify at least one user designated for said request; further wherein said at least one user is characterized a profiling-contextual-vector comprising at least one characteristic selected from a group consisting of: location, gender, income, education, profession, age, favorite categories, former impressions, former clicks, former conversions, favorite categories, restricted categories, and any combination thereof; further wherein said at least one user's profiling-contextual-vector is used to calculate at least two said estimated-CTRs ECTRᵢ, at least two said estimated-CRs ECRᵢ, or both;
said processor [110] further configured to identify at least one user designated for said request; further wherein said at least one user is characterized a profiling-contextual-vector comprising at least one characteristic selected from a group consisting of: location, gender, income, education, profession, age, favorite categories, former impressions, former clicks, former conversions, favorite categories, restricted categories, and any combination thereof; further wherein said parsing is conducted off-line or near real-time; and,
e. any combination thereof.
